(19) United States
(12) Patent Application Publication
(10) Pub. No.: US 2025/0130936 A1
(43) Pub. Date: Apr. 24, 2025

(54) MULTIPLEXED-RANK DUAL INLINE MEMORY MODULE (MRDIMM) VIRTUAL CONTROLLER MODE

(71) Applicant: Advanced Micro Devices, Inc., Santa Clara, CA (US)

(72) Inventors: James R. Magro, Lakeway, TX (US); Kedarnath Balakrishnan, Bangalore (IN)

(73) Assignee: Advanced Micro Devices, Inc., Santa Clara, CA (US)

(21) Appl. No.: 18/620,529

(22) Filed: Mar. 28, 2024

Related U.S. Application Data
(60) Provisional application No. 63/544,807, filed on Oct. 19, 2023.

(51) Int. Cl. G06F 12/02

(52) U.S. Cl. CPC G06F 12/023

(57) ABSTRACT

A memory controller includes a command queue stage, an arbitration stage, and a dispatch queue. The command queue stage stores decoded memory access requests. The arbitration stage is operable to select first and second memory commands from the command queue stage for first and second pseudo-channels, respectively, using a shred resource. The dispatch queue has first and second upstream ports for receiving the first and second memory commands, and a downstream port for conducting first data of the first memory commands time-multiplexed with second data of the second memory commands.

### BACKGROUND

Modern dynamic random-access memory (DRAM) provides high memory bandwidth by increasing the speed of data transmission on the bus connecting the DRAM and one or more data processors, such as graphics processing units (GPUs), central processing units (CPUs), and the like. DRAM is typically inexpensive and high density, thereby enabling large amounts of DRAM to be integrated per device. Most DRAM chips sold today are compatible with various double data rate (DDR) DRAM standards promulgated by the Joint Electron Devices Engineering Council (JEDEC). Typically, several DDR DRAM chips are combined onto a single printed circuit board substrate to form a memory module that can provide not only relatively high speed but also scalability. Higher processing and storage capabilities are especially useful in applications such as high-end servers for data centers, and new memory types that improve memory access speed at reasonable costs and memory controllers that can exploit their features are desirable.

### BRIEF DESCRIPTION OF THE DRAWINGS

FIG. 1 illustrates in block diagram form a data processing system with a memory system according to some implementations;

FIG. 2 illustrates in block diagram form a memory access architecture for use with the MRDIMMs of FIG. 1 according to some implementations;

FIG. 3 illustrates a timing diagram useful in understanding the interface between the memory controller and MRDIMMs of FIGS. 1 and 2 according to some implementations;

FIG. 4 illustrates in block diagram form a memory controller with an MRDIMM virtual controller mode according to some implementations;

FIG. 5 illustrates a block diagram of a memory controller with a MRDIMM virtual controller mode according to other implementations; and

FIG. 6 illustrates a flow chart of a method for accessing memory according to some implementations.

In the following description, the use of the same reference numerals in different drawings indicates similar or identical items. Unless otherwise noted, the word “coupled” and its associated verb forms include both direct connection and indirect electrical connection by means known in the art, and unless otherwise noted any description of direct connection implies alternate implementations using suitable forms of indirect electrical connection as well. The following Detailed Description is directed to electronic circuitry, and the description of a block shown in a drawing figure implies the implementation of the described function using suitable electronic circuitry, unless otherwise noted.

### DETAILED DESCRIPTION OF ILLUSTRATIVE IMPLEMENTATIONS

A memory controller includes a command queue stage, an arbitration stage, and a dispatch queue. The command queue stage stores decoded memory access requests. The arbitration stage is operable to select first and second memory commands from the command queue stage for first and second pseudo-channels, respectively, using a shared resource. The dispatch queue has first and second upstream ports for receiving the first and second memory commands, respectively, and a downstream port for conducting first data of the first memory commands time-multiplexed with second data of the second memory commands.

A data processing system includes a plurality of data processor cores each for generating memory access requests, a data fabric, and at least one memory controller. The data fabric selectively routes the memory access requests and memory access responses between the plurality of data processor cores and the at least one memory controller. Each of the at least one memory controller includes a command queue stage, an arbitration stage, and a dispatch queue. The command queue stage is for storing decoded memory access requests. The arbitration stage is operable to select first and second memory commands from the command queue stage for first and second pseudo-channels, respectively, using a shared resource. The dispatch queue has first and second upstream ports for receiving the first and seconds memory commands, respectively, and a downstream port for conducting first data of the first memory commands time-multiplexed with second data of the second memory commands.

A method for accessing a memory includes storing memory access requests in a command queue stage, wherein each memory access request accesses one of a first pseudo-channel and a second pseudo-channel of the memory. An arbitration stage arbitrates among the memory access requests to obtain first arbitration winners for the first pseudo-channel and second arbitration winners for the second pseudo-channel using a shared resource. First memory access requests of the first pseudo-channel and second memory access requests of the second pseudo-channel are overlapped by a dispatch queue stage. First data of the first memory access requests and second data of the second memory access requests are time-division multiplexed by the dispatch queue stage.

A new, emerging form of memory known as multiplexed-rank dual-inline memory module (MRDIMM) increases available memory bandwidth compared to other known DIMMs by time-multiplexing data on a data bus between the memory controller and the MRDIMM for two pseudo channels, and operating the data bus at a very high speed enabled by modern integrated circuit manufacturing technology. On the MRDIMM, the data is de-multiplexed and conducted using lower-cost, lower-speed off-the-shelf memory chips forming the two pseudo channels. A memory controller disclosed herein leverages these features of MRDIMMs to implement a virtual controller mode known as “MR-VCM” in which the memory controller includes one or more shared resources, e.g., circuits, that are shared between the two pseudo channels. MR-VCM allows the memory to appear to the system as if there were two independent channels, while reducing the amount of extra circuitry beyond that required by a single memory channel controller using the resource. An exemplary data processing system architecture requiring high memory bandwidth that could benefit from the use of MRDIMM memory and the MR-VCM feature will first be described.

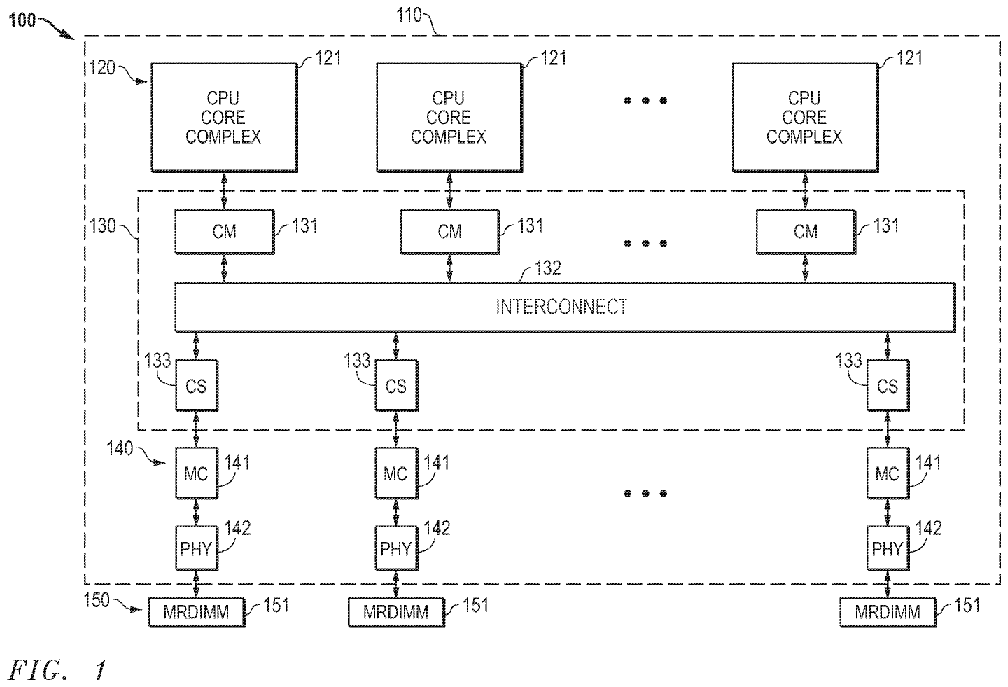

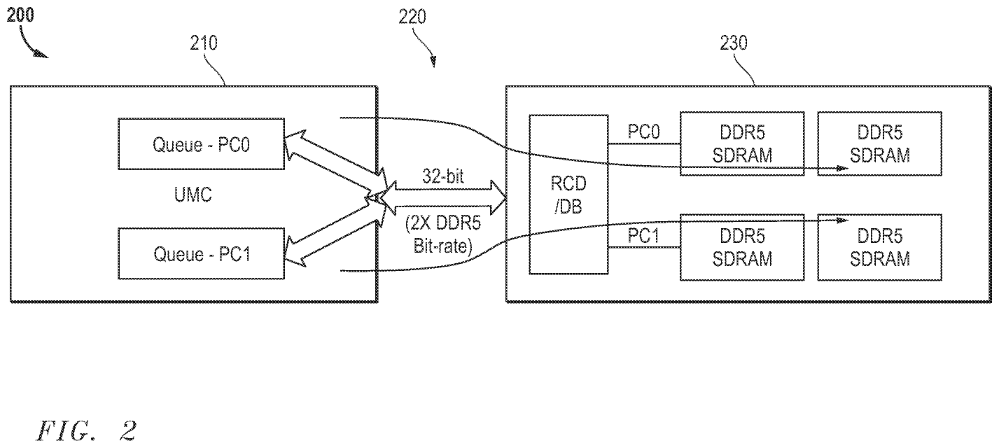

FIG. 1 illustrates in block diagram form a data processing system 100 with a memory system 150 according to some implementations. Data processing system 100 includes generally a data processor 110 and memory system 150.

Data processor 110 includes a set of CPU core complexes 120, a data fabric 130, and a set of memory access circuits 140. CPU core complexes 120 include a representative set of three CPU core complexes 121 including a first CPU core complex, a second CPU core complex, and a third CPU core complex. In various implementations, the CPU core complexes could include other types of data processing cores, including graphics processing unit (GPU) cores, digital signal processing (DSP) cores, single-instruction, multiple data (SIMD) cores, neural processor cores, and the like. Each CPU core complex 121 has a downstream bidirectional port for communicating with memory and peripherals (not shown) through a data fabric 130 in response program threads implemented by stored program instructions.

Data fabric 130 includes a set of upstream ports known as coherent master ports 131 labelled “CM” and a set of downstream ports known as coherent slave ports 133 labelled “CS” interconnected with each other through an interconnect 132. As used herein, “upstream” means in a direction toward CPU core complexes 120 and away from memory system 150. Each coherent master port 131 has an upstream bidirectional bus connected to a respective one of CPU core complexes 121, and a downstream bidirectional bus connected to interconnect 132. Crossbar switch is a large interconnect that selectively routes accesses between CPU core complexes 121 and memory system 150. Each coherent slave port 133 has an upstream bidirectional port connected to interconnect 132, and a downstream bidirectional port connected to a corresponding one of memory controllers 141.

Each memory access circuit 140 includes a memory controller 141 labelled “MC” and a physical interface circuit 142 labelled “PHY”. Each memory controller 141 has a bidirectional upstream port connected to a downstream port of a respective one of coherent slave ports 133, and a bidirectional downstream port. Each physical interface circuit 142 has a bidirectional upstream port connected to a bidirectional downstream port of a respective memory channel controller, and a bidirectional downstream port connected to memory system 150.

Memory system 150 includes a set of multiplexed rank dual inline memory modules (MRDIMMs) 151 each having a bidirectional upstream port connected to downstream bidirectional port of a respective one of physical interface circuits 142.

Data processing system 100 is a high-performance data processing system such as a server processor for a data center. It supports a high memory bandwidth by providing a large memory space using multiple memory channels accessible by each of a set of processor cores in each of several CPU core complexes.

According to various implementations disclosed herein, each memory access circuit 140 implements a virtual controller (VC) mode for the MRDIMM memory type. The MRDIMM implements two channels, known as “pseudo channels”, on the DIMM that are accessed using a very high-speed interface between the memory controller and the MRDIMM. Instead of duplicating memory controller circuitry to access each pseudo channel, the memory controller advantageously shares certain resources among the pseudo channels to significantly reduce chip cost with only a very small impact on performance.

MRDIMM is a new, emerging memory standard that leverages the high bus speed of double data rate, version five (DDR5) memory to provide the high bandwidth supported. By implementing the virtual controller mode, data processor 110 can support both pseudo channels with less extra circuitry beyond a non-MRDIMM system. Relevant aspects of the MRDIMM architecture will now be described.

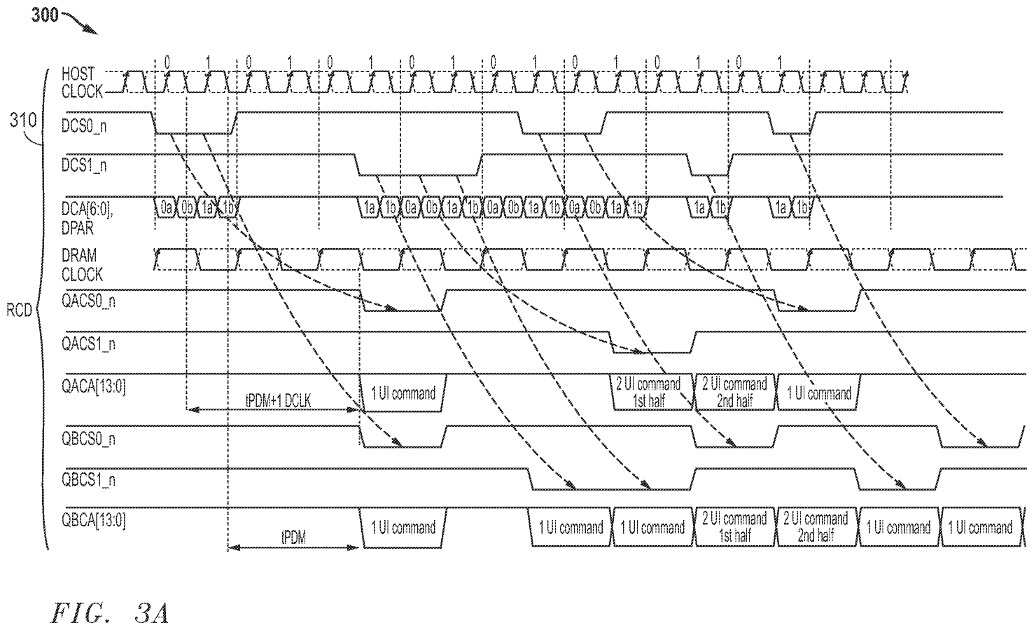

FIG. 2 illustrates in block diagram form a memory accessing architecture 200 suitable for use with MRDIMMs 151 of FIG. 1 according to some implementations. Memory accessing architecture 200 includes a memory controller 210 labelled “UMC”, a memory bus 220, and an MRDIMM 230. Internally, memory controller 210 maintains two queues for storing accesses for each respective pseudo-channel, labelled “Queue—PC0” and “Queue—PC1”, in which “PC0” corresponds to pseudo channel 0 and “PC1” corresponds to pseudo channel 1, as well as other circuitry not shown in FIG. 2.

According to the MRDIMM configuration, memory command and response signals for both PC0 and PC1 are transmitted to MRDIMM 230 using a single interface that operates at twice the rate of memory controller 210 and of MRDIMM 230. The individual memory chips on the MRDIMM operate according to the DDR5 standard. The DDR5 standard provides various speed enhancements such as decision feedback equalization (DFE) on receivers that provide very reliable operation at high clock speeds. Because DDR5 is standardized, it is expected to provide very high performance at reasonably low prices. In other implementations, other current and future memory types that are relatively high speed, standardized memories can be used in place of DDR5 memory

MRDIMM 230 includes a register clock driver and data buffer block labelled “RCD/DB” that may be implemented with separate chips, a first channel corresponding to PC0 having two ranks of DDR5 memory chips, and a second channel corresponding to PC1 also having two ranks of DDR5 memory chips. The RCD/DB block separates the memory accesses for PC0 from the memory accesses for PC1 and routes them to the corresponding pseudo channel on MRDIMM 230, as shown by the two thin arrows in FIG. 2.

Several features of memory accessing architecture 200 and memory controller 210 cooperate to provide high performance and/or low cost. First, MRDIMM 230 uses memory chips operating according to the JEDEC DDR5 specification. Since they are commodity memory chips operating according to a public standard, they will keep system cost low for the level of performance offered.

Second, memory bus 220 uses the well-known DDR5 memory interface that is capable of operating at very high speeds. For example, DDR5 receivers use decision feedback equalization (DFE) for improved reliability and low bit error rates while operating at very high speeds.

Third, MRDIMM 230 moves the virtualization point of the two pseudo channels to RCD/DB 231, such that a single physical channel—memory bus 220—exists between memory controller 210 and MRDIMM 230. MRDIMM 230, however, supports two pseudo-channels. i.e., virtual channels, on MRDIMM 230.

Fourth, as will now be described, memory controller 210 has a virtual controller mode (VCM) in which some memory controller hardware is shared between the PC0 and PC1 sub-channels. The manner in which memory controller 210 implements VCM will now be described.

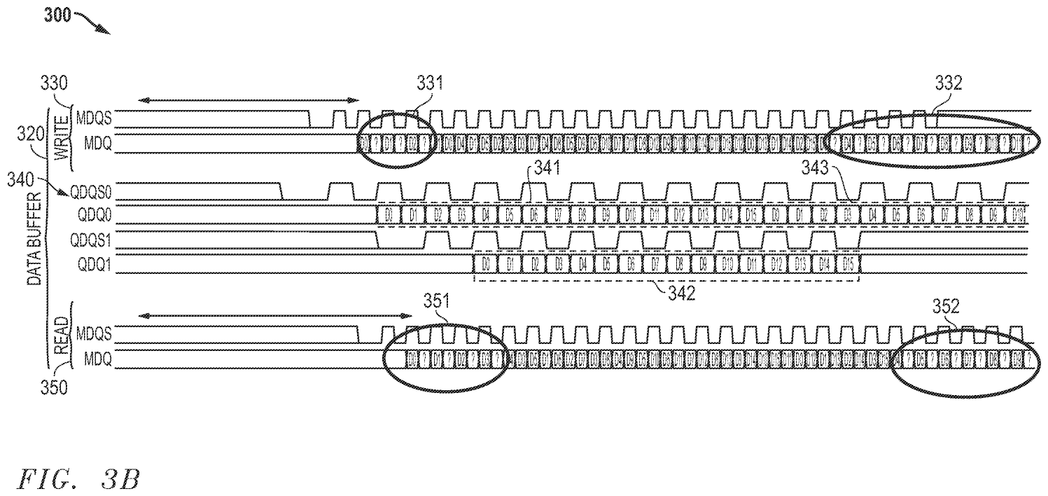

FIG. 3 illustrates a timing diagram 300 useful in understanding the interface between the memory controller and MRDIMMs of FIGS. 1 and 2 according to some implementations. FIG. 3 includes FIG. 3A showing a set of RCD signals 310 transmitted between physical interface circuit 142 and the memories on the MRDIMM using the RCD, and FIG. 3B showing a set of DB signals transmitted between the physical interface circuit and the memories on the MRDIMM using the DB. Both RCD signals 310 and DB signals 320 illustrate a multiplexed mode of operation.

In FIG. 3A, the horizontal axis represents time in picoseconds (ps), and the vertical axis represents the states of various signals. RCD signals 310 include a first sub-group of signals transmitted between the physical interface circuit and the RCD, and a second sub-group of signals transmitted between the RCD and the memory chips. The first sub-group of signals includes a host clock signal labelled “HOST CLOCK”, a chip select signal labelled “DCS0_n” that selects memory chips on Rank 0 of a channel n, a chip select signal labelled “DCS1” that selects memory chips on Rank 1 of channel n, and command and address signals collectively labelled “DCA[6:0]”, along with a parity signal labelled “DPAR”. The RCD receives and buffers these multiplexed command and address signals and distributes them to the DRAM chips on the selected one of PC0 and PC1. It outputs a memory clock signal labelled “DRAM CLOCK”, a chip select signal labelled “QACS0_n” for Rank 0 of PC0, a chip select signal labelled “QACS1_n” for Rank 1 of PC1, and a command and address signal for Rank 0 both PC0 and PC1 labelled “QACA[13:0]”. The DRAM CLOCK signal operates at half the rate of the HOST CLOCK signal, but the RCD separates the commands for PC0 and PC1 and provides them to their respective buses. In timing diagram 300, the commands are either read or write commands, but both pseudo channels operate using the same type of commands at the same time, either read or write, to avoid contention on the data bus.

As shown in timing diagram 300, the DCA[6:0] signals conduct a command for Rank 0 of PC0 followed by a command for Rank 0 of PC1, including four consecutive command and address portions transmitted on four consecutive edges of the higher speed HOST CLOCK signal from the physical interface circuit to the RCD, labelled “0a”, “0b”, “1a”, and “1b”, respectively. The RCD combines these signals into corresponding commands on the PC0 and PC1 buses formed by two command and address portions transmitted on two consecutive rising edges of the lower speed DRAM CLOCK signal transmitted by the RCD to the memory chips. Thus, a first command for Rank 0 of PC0 is transmitted from the PHY to the RCD during the even or “0” HOST CLOCK cycle, including two command and address portions labelled “0a” and “0b”. The active state of the DCS0_n signal during the even clock cycle causes the activation of the RCD output signal QACS0_n at a time period of t_{PDM}+1 DCLK after the second command and address unit 0b is received by the RCD. The RCD transmits the concatenated 14-bit command on the QACA[13:0] signals for Rank 0 of PC0 and selects it by activating chip select signal QACS0_n. The command lasts for a complete cycle of the DRAM CLOCK signal and is thus a one-unit interval (1 UI) command. Correspondingly, a second command for Rank 0 of PC1 is transmitted from the PHY to the RCD during the odd or “1” HOST CLOCK cycle, including two command and address portions labelled “1a” and “1b”. The active state of the DCS0_n signal during the odd clock cycle causes the activation of the RCD output signal QBCS0_n a time t_{PDM} after the second command and address unit 1b is received by the RCD. The RCD activates the concatenated 14-bit command on the QBCA[13:0] signals for Rank 0 of PC1 and selects it by activating chip select signal QBCS0_n.

Subsequently, a third command for Rank 1 of PC1 is transmitted from the PHY to the RCD during the odd or “1” HOST CLOCK cycle, including two command and address portions 1a and 1b. The active state of the DCS1_n signal during the odd clock cycle causes the activation of the RCD output signal QBCS1_n. The RCD activates the concatenated 14-bit command on the QBCA[13:0] signals for Rank 1, selected by an active state of chip select signal QCS1_n. A fourth command for Rank 1 of PC0 is transmitted from the PHY to the RCD during the next even HOST CLOCK cycle, including two command and address portions 0a and 0b. The continued active state of the DCS1_n signal during the even clock cycle causes the activation of the RCD output signal QACS1_n. In the example shown, Rank 1 of PC0 receives a 2 UI command in which the second portion is subsequently received to provide a continuous command stream on Rank 1 of PC0. A fifth command for Rank 1 of PC1 is transmitted from the PHY to the RCD during the next odd HOST CLOCK cycle, including two command and address portions 1a and 1b. The continued active state of the DCS1_n signal during the odd clock cycle causes the activation of the RCD output signal QBCS1_n. In the example shown, Rank 1 of PC1 receives two 1 UI commands to provide a continuous command stream on Rank 1 of PC0. The RCD activates the concatenated 14-bit command on the QBCA[13:0] signals for PC1, selected by an active state of chip select signal QBCS0_n. This pattern continues for different combinations of cycles as shown in FIG. 3A.

Thus, the PHY and RCD are able to support a dual-rank mode per pseudo channel by multiplexing the command and address signals on the higher speed PHY-to-RCD interface, while using the even and odd HOST CLOCK cycles to multiplex command and address and chip select signals onto the desired pseudo channel.

In FIG. 3B, DB signals 320 include a write signal group 330, a common signal group 340, and a read signal group 350. Write signal group 330 includes a strobe signal MDQS and a corresponding data signal MDQ output from the physical interface circuit to the DB on the memory bus. Common signal group 340 includes a strobe signal QDQS0 and data input/output signals QDQ0 for PC0, and a strobe signal QDQS1 and data input/output signals QDQ1 for PC1. Read signal group 350 includes a strobe signal MDQS and a corresponding data signal MDQ provided as an output from the DB to the PHY for PC1. The data for both PC0 and PC1 is time-division multiplexed on the memory bus during both write and read cycles, but conducted separately between the DB and the memory chips at a slower rate. Timing diagram 300 shows that very high efficiency at up to twice the maximum clock speed of the DRAM chips can be achieved if there is continuous traffic for both PC0 and PC1. Timing diagram 300 shows periods in which only one pseudo channel is used, i.e., during periods 331 and 332 for write cycles and periods 351 and 352 for read cycles periods, but also periods of continuous data bus utilization between them.

As shown in timing diagram 300, a command causes the memory chips on the PC0 bus to conduct a burst of length 16 containing data elements D0 through D15 that are provided on consecutive edges of the QDQS0 strobe signal on the PC0 bus. For a write cycle, data elements DQ0 through DQ15 are received on alternating edges of the higher speed MDQS strobe signal on the memory bus and driven for longer periods of time on the PC0 bus based on alternating edges of the QDQS strobe signal. This pattern is repeated for a subsequent command and results in continuous data being driven on the PC0 bus as long as the delay from the first command to the subsequent command is equal to the minimum command-to-command delay time shown by the two horizontal arrows in timing diagram 300. Timing diagram 300 shows an example in which a command for PC1 is received by the RCD immediately after command and results in a data burst on the QDQ1 bus.

Correspondingly, during a read cycle, commands are driven from the physical interface circuit to the RCD in a similar fashion, but for a read cycle data is provided by the memory chips to the memory controller a delay period after the read commands. The DB time-division multiplexes alternating read data from PC0 and PC1 and provides the read data on the MDQ bus to the physical interface circuit on alternative edges of the higher speed MDQS signal.

The overall bus utilization depends on the timing of the issuance of commands, but if commands are not available, the utilization of the memory bus will be reduced from the peak rate of 100% to lower rates determined by periods of isolated commands. In the example of timing diagram 300, the memory data bus is under-utilized during a write cycle during two periods 331 and 332, which corresponds to periods of consecutive commands on PC0 but only an isolated command on PC1. Likewise, the memory data bus is under-utilized during a read cycle during two periods 351 and 352, which corresponds to periods of consecutive commands on PC0 but only an isolated command on PC1. Conversely, however, the overall utilization of the memory bus can approach 100% during periods of consecutive commands with minimum command-to-command spacing with a bandwidth of twice that of a conventional DIMM. Moreover, this technique can be accomplished using DRAM chips that only operate at a slower speed, as long as data can be transferred on the memory bus at the higher speed. In the example shown in timing diagram 300, the higher speed is twice the lower speed.

In general, the RCD and DB can support multiple different modes for mapping the commands from the processor to the pseudo channels on the MRDIMMs. Timing diagram 300 shows one exemplary mode in which each DCS signal and corresponding command maps to a different pseudo channel. In another example, a single DCS signal can map to two pseudo channels in which commands are sent to the RCD on alternative even and odd unit intervals.

According to various implementations described herein, the data processing system has a virtual controller mode, known as MR-VCM, in which various memory controller resources are shared between the pseudo channels. Using MR-VCM, the memory controller allows a nearly independent selection of commands between each pseudo channel, subject only to the limitation of operating the memory data bus in the same direction, either read or write, at the same time. Two exemplary implementations of memory controllers using MR-VCM will now be described.

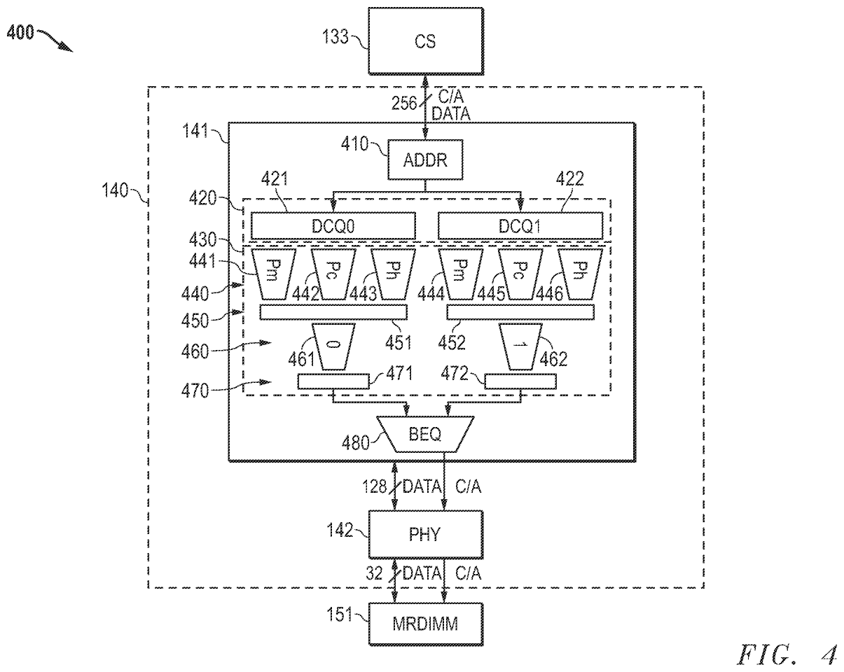

FIG. 4 illustrates a block diagram of a portion of a data processing system 400 including a memory access circuit 140 with an MRDIMM virtual controller mode according to some implementations. Data processing system 400 includes part of a data processor and MRDIMM 151. Data processing system 400 includes a coherent slave port 133, a memory access circuit 140, and an MRDIMM 151.

Memory access circuit 140 includes memory controller 141 and physical interface circuit 142. Memory controller 141 is bidirectionally connected to coherent slave port 133. In the example shown in FIG. 4, coherent slave port 133 supports 256-bit data transfers. Coherent slave port. 133 also provides command and address (C/A) signals that indicate the type of access, either read or write, and the address of the access.

Memory controller 141 includes an address decoder 410, a command queue stage 420, an arbiter 430, and a dispatch queue 480 labelled “BEQ” Address decoder 410 has an upstream port connected to coherent slave port 133 for receiving memory access requests and providing memory access responses, and a downstream port. Address decoder 410 decodes and maps addresses of memory access requests to addresses of memory in MRDIMM 151. When the addresses are decoded, the memory accesses requests are assigned to either PC0 or PC1 by decoding one or more bits of the addresses received from coherent slave port 133.

Command queue stage 420 includes a command queue 421 for PC0 labelled “DCQ0”, and a command queue 422 for PC1 labelled “DCQ1”. Command queue 421 has an upstream port connected to the downstream port of address decoder 410, and stores accesses to PC0 that are awaiting arbitration. Command queue 422 has an upstream port connected to the downstream port of address decoder 410, and stores accesses to PC1 that are awaiting arbitration. Accesses that are stored in command queue stage 420 can be issued to the memory in a different order to promote efficiency in usage of the DRAM bus, while maintaining fairness of all accesses so they make progress toward completion.

In data processing system 400, arbiter 430 includes separate arbitration circuitry for each pseudo channel organized into a sub-arbitration stage 440, a register stage 450, a final arbitration stage 460, and a register stage 470.

Sub-arbitration stage 440 includes a page miss sub-arbiter 441 labelled “Pm” for PC0 connected to command queue 421 for arbitrating among memory access requests to closed pages, a page conflict sub-arbiter 442 labelled “Pc” for PC0 connected to command queue 421 for arbitrating among memory access requests to closed pages when another page in the accessed memory bank is open, and a page hit sub-arbiter 443 labelled “Ph” for PC0 connected to command queue 421 for arbitrating among memory access requests to open pages in the accessed bank. Sub-arbitration stage 440 also includes a page miss sub-arbiter 444 labelled “Pm” for PC1 connected to command queue 422 for arbitrating among memory access requests to closed pages, a page conflict sub-arbiter 445 labelled “Pc” for PC1 connected to command queue 422 for arbitrating among memory access requests to closed pages when another page in the accessed memory bank is open, and a page hit sub-arbiter 446 labelled “Ph” for PC1 having an upstream port connected to command queue 422 that arbitrates among memory access requests to open pages in the accessed bank.

Register stage 450 includes a register 451 for PC0 and a register 452 for PC1. Register 451 is connected to outputs of each sub-arbiter for PC0 including page miss sub-arbiter 441, page conflict sub-arbiter 442, and page hit sub-arbiter 443, and stores sub-arbitration winners from each of page miss sub-arbiter 441, page conflict sub-arbiter 442, and page hit sub-arbiter 443 during a command arbitration cycle. Register 452 is connected to the outputs of each sub-arbiter for PC1 including page miss sub-arbiter 444, page conflict sub-arbiter 445, and page hit sub-arbiter 446, and stores sub-arbitration winners from each of page miss sub-arbiter 441, page conflict sub-arbiter 442, and page bit sub-arbiter 443 during a command arbitration cycle.

Final arbitration stage 460 selects between the sub-arbitration winners to provide a final arbitration winner for each of PC0 and PC1. Final arbitration stage 460 includes a final arbiter 461 labelled “0” for PC0 and a final arbiter 462 labelled “1” for PC1. Final arbiter 461 is connected to register 451 and selects from among the three sub-arbitration winners for PC0 to provide a final arbitration winner in each controller cycle to a downstream port. Likewise, final arbiter 462 is connected to register 452 and selects from among the three sub-arbitration winners for PC1 to provide a final arbitration winner in each controller cycle to a downstream port. For each final arbiter, the different types of accesses from the sub-arbitration winners can be advantageously mixed so that, for example, a page hit access can be followed by a page miss access or a page conflict access to hide or partially hide the overhead of opening a new page or closing an open page and opening a new page, respectively.

A register stage 470 stores the final arbitration winner for each pseudo channel, and includes a register 471 connected to the downstream port of final arbiter 461, and a register 472 connected to the output of final arbiter 462. In some implementations, two final arbitration winners, one from each of PC0 and PC1, can be selected each memory controller cycle.

A dispatch queue 480 (BEQ) interleaves the accesses from the two pseudo channels into a single command and address stream with accompanying data (for a write cycle) or while receiving data (for a write cycle) as described with respect to FIG. 3 above.

A bus known as the DDR-to-PHY (DFI) Interface is used to communicate signals between memory controller 141 and physical interface circuit 142. The DFI Interface is an industry-defined specification that allows interoperability among various memory controller and PHY designs, which are typically made by different companies. It is expected that the signal timings discussed herein will be adopted as a part of future versions of the DFI protocol to support MRDIMMs.

Physical interface circuit 142 communicates with MRDIMM 151 over a memory bus that operates at very high speed and bandwidth. In various implementations, the memory bus is expected to operate at twice the speed of the DFI bus. Since it transfers data on each half cycle of the clock signal, it can perform four 32-bit in the same amount of time that the DFI bus performs one 128-bit transfer of data.

According to the MRDIMM technique, consecutive commands can be issued to alternate pseudo channels on the MRDIMM while the data of PC0 and PC1 is interleaved on the memory bus. During write cycles, data from the memory access requests for the two pseudo channels can then be separated by the data buffer on the MRDIMM and synchronized using the RCD on the MRDIMM so that accesses to the memories on the two pseudo channels on the DIMM can take place substantially in parallel. During read cycles, data from the memory access requests for the two pseudo channels is combined by the data buffer on the MRDIMM and synchronized using the RCD on the MRDIMM, and transferred to the data processor over the memory bus. For both read and write cycles, accesses to the memories on the two pseudo channels on the DIMM can take place substantially in parallel. Thus, the MRDIMM technique leverages the high speed operating capability of the DDR5 bus to almost double the effective memory bandwidth.

A single command and address stream is provided to physical interface circuit 142. In the illustrated example, physical interface circuit 142 operates at twice the speed of memory controller 141 and of the pseudo-channel buses on MRDIMM 230. Thus, for every 256-bit data access received from coherent slave port 133, memory controller 141 issues two 128-bit accesses and transfers data at twice the speed over the data bus. The memory chips connected to PC0 and PC1 operate at half the overall rate as well.

Data processing system 400 shares the following circuit elements between PC0 and PC1: address decoder 431, dispatch queue 480, and physical interface circuit 142. In this implementation, the command queues, sub-arbiters, and final arbiters are dedicated to their respective pseudo-channels. As will now be described, more resources of the memory controller can be shared between the pseudo-channels to further reduce chip area and cost.

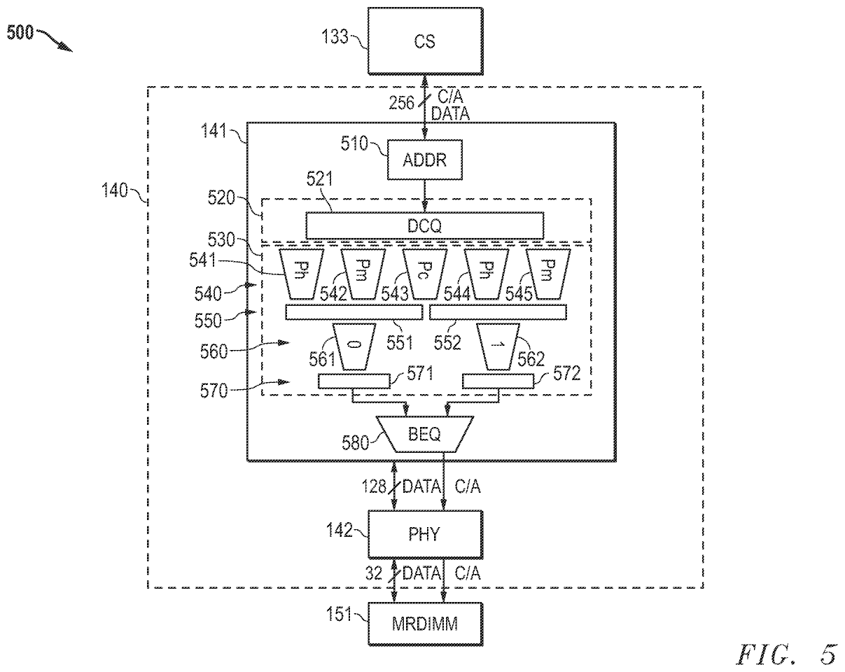

FIG. 5 illustrates a block diagram of a portion of a data processing system 500 including a memory access circuit 140 with an MRDIMM virtual controller mode according to some implementations. Data processing system 500 includes part of a data processor and MRDIMM 151. Data processing system 400 includes a coherent slave port 133, a memory access circuit 140, and an MRDIMM 151.

Memory access circuit 140 includes memory controller 141 and physical interface circuit 142. Memory controller 141 is bidirectionally connected to coherent slave port 133. In the example shown in FIG. 5, coherent slave port 133 supports 256-bit data transfers. Coherent slave port 133 also provides command and address (C/A) signals that indicate the type of access, either read or write, and the address of the access.

Memory controller 141 includes an address decoder 510, a command queue stage 520, an arbitration stage 530, and a dispatch queue 580 labelled “BEQ”. Address decoder 510 has an upstream port connected to coherent slave port 133 for receiving memory access requests and providing memory access responses, and a downstream port. Address decoder 510 decodes and maps addresses of memory access requests to addresses of memory in MRDIMM 151. When the addresses are decoded, the memory accesses requests are assigned to either PC0 or PC1 by decoding one or more bits of the addresses received from coherent slave port 133.

Command queue stage 520 includes a single command queue 521 for both PC0 and PC1 labelled “DCQ”. Command queue 521 has an upstream port connected to the downstream port of address decoder 510, and stores accesses to both PC0 and PC1 that are awaiting arbitration. Accesses that are stored in command queue 521 can be issued to the memory in a different order to promote efficiency in usage of the DRAM bus, while maintaining fairness of all accesses so they make progress toward completion.

In data processing system 500, arbitration stage 530 includes separate arbitration circuitry for each pseudo channel organized into a sub-arbitration stage 540, a register stage 550, a final arbitration stage 560, and a register stage 570.

Sub-arbitration stage 540 includes a page hit sub-arbiter 541 (Ph) for PC0 connected to command queue 521 for arbitrating among memory access requests to open pages in the accessed bank, and a page miss sub-arbiter 542 (Pm) for PC0 connected to command queue 521 for arbitrating among memory access requests to closed pages. Sub-arbitration stage 540 also includes a page hit sub-arbiter 446 (Ph) for PC1 having an upstream port connected to command queue 521 that arbitrates among memory access requests to open pages in the accessed bank, and a page miss sub-arbiter 545 (Pm) for PC1 connected to command queue 521 for arbitrating among memory access requests to closed pages. Finally, sub-arbitration stage 540 includes a page conflict sub-arbiter 442 (Pc) for both PC0 and PC1 connected to command queue 521 for arbitrating among memory access requests to closed pages when another page in the accessed memory bank is open.

Register stage 550 includes a register 551 for PC0 and a register 552 for PC1. Register 551 is connected to outputs of each sub-arbiter for PC0 including page hit sub-arbiter 541 and page miss sub-arbiter 542, as well as to page conflict sub-arbiter 543, and stores sub-arbitration winners from each of them during a command arbitration cycle. Register 452 is connected to outputs of each sub-arbiter for PC1 including page hit sub-arbiter 544 and page miss sub-arbiter 545, as well as to page conflict sub-arbiter 543, and stores sub-arbitration winners from each of them during a command arbitration cycle.

A final arbitration stage 560 selects between the sub-arbitration winners to provide a final arbitration winner for each of PC0 and PC1. Final arbitration stage 560 includes a final arbiter 561 (0) for PC0 and a final arbiter 562 (1) for PC1. Final arbiter 561 is connected to register 551 and selects from among the three sub-arbitration winners for PC0 to provide a final arbitration winner in each controller cycle to a downstream port. Likewise, final arbiter 562 is connected to register 552 and selects from among the three sub-arbitration winners for PC1 to provide a final arbitration winner in each controller cycle to a downstream port. As before, for each final arbiter, the different types of accesses from the sub-arbitration winners can be advantageously mixed so that, for example, a page hit access can be followed by a page miss access or a page conflict access to hide or partially hide the overhead of opening a new page or closing an open page and opening a new page, respectively.

A register stage 570 stores the final arbitration winner for each pseudo channel, and includes a register 571 connected to the downstream port of final arbiter 561, and a register 572 connected to the output of final arbiter 562. In some implementations, two final arbitration winners, one from each of PC0 and PC1, can be selected each memory controller cycle.

A dispatch queue 580 (BEQ) interleaves the accesses from the two pseudo channels into a single command and address stream with accompanying data (for a write cycle) or while receiving data (for a write cycle) as described with respect to FIG. 3 above.

A DFI Interface is used to communicate signals between memory controller 141 and physical interface circuit 142.

Physical interface circuit 142 communicates with MRDIMM 151 over a memory bus that operates at very high speed and bandwidth, and it can perform four 32-bit in the same amount of time that the DFI bus performs one 128-bit transfer of data.

The virtual controller mode implemented by data processing system 500 is similar to the virtual controller mode implemented by data processing system 400 but data processing system 500 is implemented using a memory controller that shares more memory controller circuit blocks than data processing system 400 of FIG. 4. Notably, data processing system 500 combines all memory accesses directed to both pseudo channels into a single command queue 521. In some implementations, the single command queue may be smaller than the combined size of command queues 421 and 422 of FIG. 4 to reduce circuit area, but may contain more entries than either command queue 421 or command queue 422 alone. Also, page conflict sub-arbiter 543 is shared between PC0 and PC1. This sharing would be advantageous, for example, if the memory controller implemented a robust page close prediction mechanism such that it rarely encountered page conflicts.

Memory controller 141 of FIG. 5 has more common circuit blocks but lower performance, whereas memory controller 141 of FIG. 4 has fewer common circuit blocks but higher performance. The sizes of the DCQs can also vary between the two implementations. For example, DCQ0 and DCQ1 in memory controller 141 of FIG. 4 together may have more entries than the combined DCQ in memory controller 141 of FIG. 5. This difference helps prevent stalling and reduces the number of “bubbles” in the memory data bus when the workloads for PC0 and PC1 are imbalanced such that one pseudo-channel runs out of accesses while the other pseudo-channel has continuous work.

Thus, a memory controller, data processor, data processing system, and method have been described that implements a virtual controller mode, known as MR-VCM, for use with MRDIMM and similar types of memory. The virtual controller mode allows the sharing of memory controller circuits between the two pseudo channels, while appearing to the system as if there were two independent channels. The MR-VCM feature allows the use of a single memory controller channel to implement two multiplexed-rank channels on the DIMM.

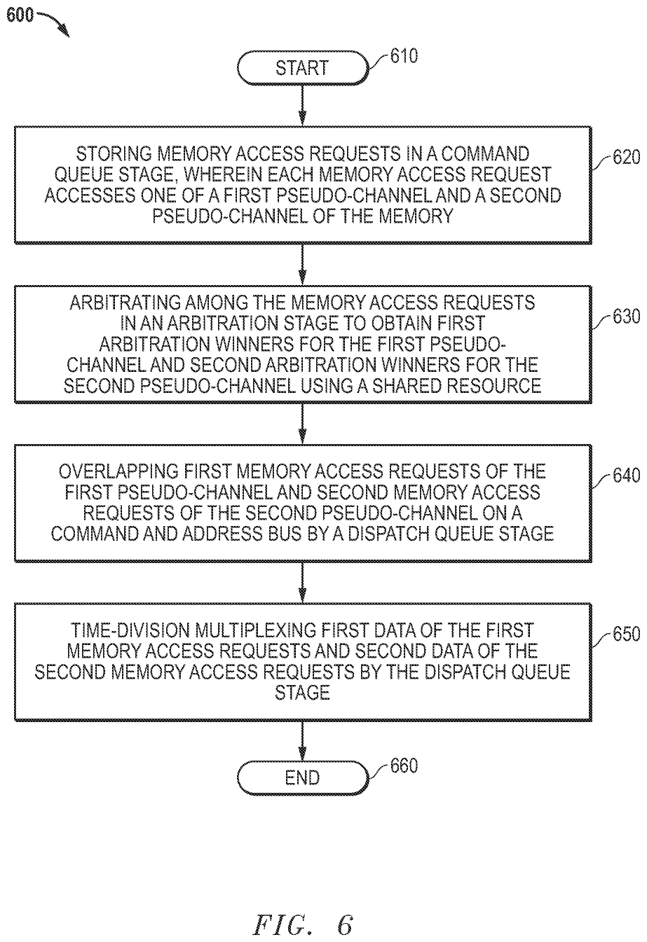

FIG. 6 illustrates a flow chart of a method 600 for accessing memory according to some implementations. Method 600 starts at box 610. An action box 620 includes storing memory access requests in a command queue stage, wherein each memory access request accesses one of a first pseudo-channel and a second pseudo-channel of the memory. An action box 630 includes arbitrating among the memory access requests in an arbitration stage to obtain first arbitration winners for the first pseudo-channel and second arbitration winners for the second pseudo-channel using a shared resource. An action box 640 includes overlapping first memory access requests of the first pseudo-channel and second memory access requests of the second pseudo-channel on a command and address bus by a dispatch queue stage. An action box 650 includes time-division multiplexing first data of the first memory access requests and second data of the second memory access requests by the dispatch queue stage. Method 600 ends at box 660.

While particular implementations have been described, various modifications of these implementations will be apparent to those skilled in the art. For example, various combinations of memory controller circuitry can be shared between two pseudo channels on the MRDIMM. In some implementations, only the command queue and dispatch queue are shared between the two pseudo channels, while in other implementations, all circuitry until the dispatch queue can be shared. In order to operate according to the MRDIMM technique, each pseudo channel must be in the same mode, read or write, to avoid contention on the memory bus, but various techniques for read and write streak management are possible. Also, the techniques disclosed herein were described with respect to one exemplary configuration of the RCD, but other configurations may be supported in other RCD modes. While various implementations have been described with respect to MRDIMMs, they are applicable to other similar memory types having pseudo channels.

Accordingly, it is intended by the appended claims to cover all modifications of the disclosed implementations that fall within the scope of the disclosed implementations.

What is claimed is:

1. A memory controller, comprising:
a command queue stage for storing decoded memory access requests;
an arbitration stage operable to select first and second memory commands from the command queue stage for first and second pseudo-channels, respectively, using a shared resource; and
a dispatch queue having a downstream port for conducting first data of the first memory commands that is time-multiplexed with second data of the second memory commands.

2. The memory controller of claim 1, further comprising:
an address decoder having an upstream port for receiving memory access requests, and a downstream port coupled to the command queue stage for providing the decoded memory access requests including a pseudo-channel number.

3. The memory controller of claim 1, wherein the command queue stage comprises:
a first command queue having an upstream port for receiving decoded memory access requests for the first pseudo-channel, and a downstream port; and
a second command queue having an upstream port for receiving decoded memory access requests for the second pseudo-channel, and a downstream port.

4. The memory controller of claim 1, wherein the arbitration stage comprises:
a first plurality of sub-arbiters for selecting decoded memory access requests of the first pseudo-channel; and
a second plurality of sub-arbiters for selecting decoded memory access requests of the second pseudo-channel.

5. The memory controller of claim 4, wherein the first plurality of sub-arbiters comprises:
a first page hit sub-arbiter for selecting decoded memory access requests to open pages of the first pseudo-channel; and
a first page miss sub-arbiter for selecting decoded memory access requests to closed pages of precharged banks of the first pseudo-channel.

6. The memory controller of claim 5, wherein the second plurality of sub-arbiters comprises:
a second page hit sub-arbiter for selecting decoded memory access requests to open pages of the second pseudo-channel; and
a second page miss sub-arbiter for selecting decoded memory access requests to closed pages of precharged banks of the second pseudo-channel,
wherein the shared resource comprises a page conflict sub-arbiter for selecting decoded memory access requests to closed pages in banks with another page that is open in the first and second pseudo-channels.

7. The memory controller of claim 1, wherein the command queue stage comprises:
a common command queue having an upstream port for receiving memory access requests for a selected one of the first pseudo-channel and the second pseudo-channel, and a downstream port.

8. The memory controller of claim 7, wherein the arbitration stage comprises:
a plurality of sub-arbiters having an upstream port coupled to the command queue stage, and a downstream port coupled to the dispatch queue, for selecting decoded memory access requests of the first pseudo-channel and the second pseudo-channel.

9. The memory controller of claim 8, wherein the plurality of sub-arbiters comprises:
at least one dedicated sub-arbiter for each of the first and second pseudo-channels; and
at least one shared sub-arbiter for both the first pseudo-channel and the second pseudo-channel.

10. The memory controller of claim 9, wherein the at least one dedicated sub-arbiter for each of the first and second pseudo-channels comprises:
a page hit sub-arbiter for selecting decoded memory access requests to open pages of a respective pseudo-channel.

11. The memory controller of claim 9, wherein the at least one shared sub-arbiter for both the first pseudo-channel and the second pseudo-channel comprises:
a page conflict sub-arbiter for selecting decoded memory access requests to closed pages in banks with another page that is open in a respective pseudo-channel.

12. A data processing system, comprising:
a plurality of data processor cores each for generating memory access requests;
a data fabric; and
at least one memory controller, wherein the data fabric selectively routes the memory access requests and memory access responses between the plurality of data processor cores and the at least one memory controller, wherein each of the at least one memory controller comprises:
a command queue stage for storing decoded memory access requests;
an arbitration stage operable to select first and second memory commands from the command queue stage for first and second pseudo-channels using a shared resource; and
a dispatch queue having first and second upstream ports for receiving the first memory commands and the second memory commands, and a downstream port for conducting first data of the first memory commands time-multiplexed with second data of the second memory commands.

13. The data processing system of claim 12, wherein:
the command queue stage comprises:
a first command queue having an upstream port for receiving decoded memory access requests for the first pseudo-channel, and a downstream port; and
a second command queue having an upstream port for receiving decoded memory access requests for the second pseudo-channel, and a downstream port, and
the arbitration stage comprises:
a first plurality of sub-arbiters for selecting decoded memory access requests of the first pseudo-channel; and
a second plurality of sub-arbiters for selecting decoded memory access requests of the second pseudo-channel.

14. The data processing system of claim 12, wherein:
the command queue stage comprises:
a common command queue having an upstream port for receiving memory access requests for a selected one of the first pseudo-channel and the second pseudo-channel, and a downstream port, and
the arbitration stage comprises:
a plurality of sub-arbiters having an upstream port coupled to the command queue stage, and a downstream port coupled to the dispatch queue, for selecting decoded memory access requests of the first pseudo-channel and the second pseudo-channel.

15. The data processing system of claim 12, further comprising:
a physical interface circuit coupled to an output of the dispatch queue; and
a memory coupled to the physical interface circuit comprising a multiplexed-rank dual inline memory module (MRDIMM).

16. A method for accessing a memory, comprising:
storing memory access requests in a command queue stage, wherein each memory access request accesses one of a first pseudo-channel and a second pseudo-channel of the memory;
arbitrating among the memory access requests in an arbitration stage to obtain first arbitration winners for the first pseudo-channel and second arbitration winners for the second pseudo-channel using a shared resource;
overlapping first memory access requests of the first pseudo-channel and second memory access requests of the second pseudo-channel on a command and address bus by a dispatch queue stage; and
time-division multiplexing first data of the first memory access requests and second data of the second memory access requests by the dispatch queue stage.

17. The method of claim 16, wherein the storing comprises:
storing memory access requests for both the first pseudo-channel and the second pseudo-channel in a common command queue.

18. The method of claim 16, wherein the arbitrating comprises:
arbitrating among the memory access requests using an arbitration stage having a sub-arbiter common to both the first pseudo-channel and the second pseudo-channel.

19. The method of claim 16, wherein the overlapping and time-division multiplexing comprises:
overlapping and time-division multiplexing using a dispatch queue common to both the first pseudo-channel and the second pseudo-channel.

20. The method of claim 16, further comprising:
receiving memory access requests by an address decoder circuit;
decoding a corresponding pseudo-channel for each of the memory accesses requests; and
sending a decoded memory access request with a decoded pseudo-channel to the command queue stage.
